(19) United States
(12) Patent Application Publication
(10) Pub. No.: US 2019/0087845 A1
(43) Pub. Date: Mar. 21, 2019

(54) SYSTEMS AND METHODS FOR PROMOTING SUBSCRIPTION SERVICES TO USERS BASED UPON DIGITAL WALLET TRANSACTION DATA

(71) Applicant: MasterCard International Incorporated, Purchase, NY (US)

(72) Inventor: Manoneet Kohli, New York, NY (US)

(21) Appl. No.: 15/707,391

(22) Filed: Sep. 18, 2017

(51) Int. Cl. G06Q 30/02; G06Q 20/34; G06Q 20/36

(52) U.S. Cl. CPC G06Q 30/0222; G06Q 20/36; G06Q 20/351; G06Q 30/0239

(57) ABSTRACT

A computer-based method for promoting subscription services to a user based upon digital wallet transaction data is provided. The method includes: (i) receiving digital wallet transaction data associated with a plurality of digital wallet transactions; (ii) analyzing the digital wallet transaction data; (iii) determining, based upon the analyzing, that the plurality of digital wallet transactions are associated with payments made for a subscription service; (iv) determining, based upon the analyzing, a status of the subscription service; (v) generating, based upon the status of the subscription service, a promotional offer in relation to at least one of the subscription service or a different subscription service; and (vi) providing the promotional offer to the user.

### BACKGROUND

This disclosure relates generally to collecting and analyzing digital wallet transaction data generated from purchases of various subscription services (e.g., internet services, television services, telephone services, music services, and the like) using a digital wallet, and more particularly, to systems and methods for promoting subscription services to users based upon digital wallet transaction data by processing digital wallet transaction data.

Consumers are often times able to use a variety of methods to perform payment transactions to purchase goods and services, including, for example, subscription services. These methods include use of cash, plastic payment cards, smartphones, and other computing devices operated by users (also known as user computing devices) that are able to provide account data and transaction data to complete a purchase. In the case of account data being communicated for the transactions, a payment processor computing device processes the payment transactions over a processing network. In the case of subscription services purchases, users typically initiate transactions when not at a merchant physical location (e.g., an online transaction initiated from home, such as to order goods from a merchant website). Such transactions are sometimes also referred to as card-not-present transactions (CNP), because a payment card is not physically presented at a merchant location. In some cases, merchant location transactions and CNP transactions may be performed using a digital wallet that is either stored on a user's smartphone as an application, or on another user computing device as an account-on-file.

A digital wallet is typically an application the user accesses from a computing device. The computing device may be a device associated with the user, for example, a smartphone, a tablet, a wearable computing device, or some other computing device. The computer device may also be a laptop, a desktop, or other electronic device. The digital wallet application allows the user to use the computing device to purchase items, including subscription services, without using a physical card. To make such a purchase, users may access their digital wallet application on the computing device and use card data saved in association with the digital wallet to purchase the subscription services.

When a digital wallet transaction is performed for purchasing a subscription service, digital wallet transaction data related to the subscription services purchase is generated. In addition, in the case of subscription services, users may in many cases purchase these services for a contract term, such as a term of twelve or twenty-four months. The digital wallet transaction data associated with the purchase of such services may therefore reflect a periodically recurring (e.g., monthly) payment. As the contractual term draws to a close, many known systems simply permit the contract term associated with the subscription services to expire. In other cases, a user may relocate, such as to a new geographic region, which may require cancellation of the subscription services, such as, for example, in the case that the merchant offering the services is unable to offer the same services within the new geographic region. Moreover, in some cases, such as prior to the expiration of the contractual term, merchants offering the subscription services are unable to capitalize on a user's satisfaction with the services. Similarly, during a subscription services term, merchants are frequently unable to offer promotional opportunities to dissatisfied or potentially dissatisfied customers.

Systems and methods for promoting subscription services to users based upon digital wallet transaction data are therefore desirable. More particularly, systems and methods capable of analyzing digital wallet transaction data, determining a status of a subscription service associated with one or more transactions included in the digital wallet transaction data, and generating one or more promotional offers in relation to the status of the subscription service are desirable. Such systems and methods permit merchants offering subscription services to communicate with users throughout the contractual term of a particular subscription service as well as to encourage users associated with expiring or expired contract terms to register for additional or new terms. In addition, such systems and methods may permit a merchant offering services in a region to which a user has relocated to offer related or similar subscription services based upon the user's history of subscription services purchases.

### BRIEF DESCRIPTION

In one aspect, a computer-based method for promoting subscription services to a user based upon digital wallet transaction data is provided. The method is performed using a transaction analysis computing device including at least one processor in communication with at least one memory device. The method includes: (i) receiving digital wallet transaction data associated with a plurality of digital wallet transactions; (ii) analyzing the digital wallet transaction data; (iii) determining, based upon the analyzing, that the plurality of digital wallet transactions are associated with payments made for a subscription service; (iv) determining, based upon the analyzing, a status of the subscription service; (v) generating, based upon the status of the subscription service, a promotional offer in relation to at least one of the subscription service or a different subscription service; and (vi) providing the promotional offer to the user.

In another aspect, a transaction analysis computing device including at least one processor in communication with at least one memory device is provided. The transaction analysis computing device is configured to: (i) receive digital wallet transaction data associated with a plurality of digital wallet transactions; (ii) analyze the digital wallet transaction data; (iii) determine, based upon the analysis, that the plurality of digital wallet transactions are associated with payments made for a subscription service; (iv) determine, based upon the analysis, a status of the subscription service; (v) generate, based upon the status of the subscription service, a promotional offer in relation to at least one of the subscription service or a different subscription service; and (vi) provide the promotional offer to the user.

In a further aspect, a non-transitory computer readable medium that includes executable instructions for selecting promotional content based on digital wallet transaction data is provided. When executed by a transaction analysis computing device including at least one processor in communication with at least one memory device, the computer executable instructions cause the transaction analysis computing device to: (i) receive digital wallet transaction data associated with a plurality of digital wallet transactions; (ii) analyze the digital wallet transaction data; (iii) determine, based upon the analysis, that the plurality of digital wallet transactions are associated with payments made for a subscription service; (iv) determine, based upon the analysis, a status of the subscription service; (v) generate, based upon the status of the subscription service, a promotional offer in relation to at least one of the subscription service or a different subscription service; and (vi) provide the promotional offer to the user.

### BRIEF DESCRIPTION OF THE DRAWINGS

FIGS. 1-7 show example embodiments of the methods and systems described herein.

FIG. 1 is a schematic diagram illustrating an example transaction analysis platform for promoting subscription services to users based upon digital wallet transaction data.

FIG. 2 is a block diagram of the transaction analysis platform shown in FIG. 1 including multiple example computing devices communicatively coupled to each other via a plurality of network connections.

FIG. 3 illustrates an example configuration of a server system that includes or is in communication with the transaction analysis computing device shown in FIG. 2.

FIG. 4 illustrates an example configuration of a user system, such as user computer device configured to transmit data to the transaction analysis computing device shown in FIG. 2.

FIG. 5 shows an example configuration of a server system, such as the transaction analysis computing device shown in FIG. 2.

FIG. 6 shows an example method flow illustrating how the transaction analysis computing device shown in FIG. 2 promotes subscription services to users based upon digital wallet transaction data.

FIG. 7 shows an example configuration of a database coupled to or included within a transaction analysis computing device, such as the transaction analysis computing device shown in FIG. 2, which includes digital wallet transaction data and promotional data.

Like numbers in the figures indicate the same or functionally similar components.

### DETAILED DESCRIPTION

The present disclosure relates to a transaction analysis computing device that receives and analyzes digital wallet transaction data to promote subscription services to users based upon an analysis of the digital wallet transaction data as described herein. Accordingly, in the exemplary embodiment the transaction analysis computing device receives digital wallet transaction data associated with one or more digital wallet transactions. For example, as described above, a user may use a digital wallet to purchase a variety of goods and services, such as, in some cases, subscription services. The digital wallet transaction data received by the transaction analysis computing device may therefore be associated with a variety of digital wallet transactions or types of digital wallet transactions, including, for example, digital wallet transactions associated with the purchase of one or more subscription services.

In various embodiments, the transaction analysis computing device may analyze the digital wallet transaction data to identify digital wallet transaction data associated with the purchase of one or more subscription services. More particularly, the transaction analysis computing device may analyze one or more attributes of the digital wallet transaction data to determine that a particular transaction or group of transactions in the digital wallet transaction data are associated with the purchase of one or more subscription services.

In some embodiments, the attributes associated with each transaction in the digital wallet transaction data may include, but are not limited to, a purchase amount associated with one or more digital wallet transactions in the digital wallet transaction data, a date and/or timestamp associated with one or more transactions in the digital wallet transaction data, an identifier or purchase code associated with one or more transactions in the digital wallet transaction data, a merchant name or merchant identifier associated with one or more transactions in the digital wallet transaction data, and the like. The transaction analysis computing device may analyze these attributes in combination with one another and/or independently to determine that a particular transaction or a particular group of transactions is associated with the purchase of a subscription service.

For example, the transaction analysis computing device may analyze a purchase amount associated with a plurality of transactions in conjunction with a date and/or timestamp associated with each of the plurality of transactions to determine that the purchase amount recurs periodically in the digital wallet transaction data associated with a particular user. Specifically, the transaction analysis computing device may determine that a particular purchase amount recurs periodically (e.g., weekly, monthly, annually) in a user's digital wallet transaction data. Such a pattern may suggest or indicate that the transactions associated with the particular purchase amount and/or date and/or timestamp are associated with a purchase of subscription services, which, as described above, may include a periodically recurring payment or billing cycle.

In addition, the transaction analysis computing device may analyze an identifier or purchase code associated with one or more transactions to determine that the one or more transactions are associated with a purchase of subscription services. For instance, a particular subscription service may be associated with or identified by an identifier, which may be applied by a merchant offering the subscription services for sale, and which may be used by the transaction analysis computing device to determine that the one or more transactions associated with the identifier are associated with a purchase of the subscription service.

Similarly, the transaction analysis computing device may analyze a merchant name and/or merchant identifier associated with one or more transactions to determine that the one or more transactions are associated with a purchase of subscription services. For example, the transaction analysis computing device may store and/or retrieve a stored record of merchant names and/or merchant identifiers associated with merchants known to offer subscription services. If a merchant name and/or merchant identifier associated with one or more transactions in the digital wallet transaction data matches a stored merchant name and/or stored merchant identifier, the transaction analysis computing device may determine that the one or more transactions are associated with a purchase of subscription services from the merchant.

Thus, the attributes associated with each transaction in the digital wallet transaction data may be analyzed, as described above, to determine that a particular transaction or group of transactions are associated with the purchase of one or more subscription services. The attributes may be analyzed independently and/or in different combinations with one another to make this determination, and as described above, an individual transaction and/or a group of transactions (such as a group of transactions recurring in the digital wallet transaction data as part of a periodic billing cycle) may be identified by the transaction analysis computing device as being associated with the purchase of a particular subscription service and/or a plurality of subscription services.

In response to determining that one or more transactions in the digital wallet transaction data are associated with the purchase of a subscription service (e.g., payments made to a merchant offering a subscription service), the transaction analysis computing device may, in addition, determine, based upon the analysis of one or more attributes associated with each transaction, a status of a particular subscription service. For example, in some embodiments, the transaction analysis computing device may analyze digital wallet transaction data associated with the purchase of a particular subscription service (identified as described above) to determine a number of payments made to the merchant offering the subscription service. In other words, the transaction analysis computing device may determine a number of transactions or transaction records in the digital wallet transaction data associated with payments made in conjunction with the purchase of a particular subscription service.

The number of payments may indicate, for example, an amount of time remaining in a user's contract term for the subscription services. For example, if a user has made eleven payments in association with the purchase of a particular subscription service, the transaction analysis computing device may determine (or infer) that the user's contract term, which may be for a period of twelve months, is about to expire. Similarly, if a user has only made one or two payments in association with the purchase of a particular subscription service, the transaction analysis computing device may determine (or infer) that the user's contract term, which, again, may be for a period of twelve months, is only just beginning.

In addition, and in some embodiments, the transaction analysis computing device may receive or obtain from a merchant offering the particular subscription service and/or a record of database of records associated with the particular subscription service, a known term of the subscription service. In such a case, it may not be necessary for the transaction analysis computing device to infer a contract term. Rather, where the transaction analysis computing device is able to obtain or determine (e.g., based upon an analysis of digital wallet data associated with a number of users who have purchased the particular subscription service) a contract term associated with a subscription service, the transaction analysis computing device may determine, based upon the known contract term, a time period or duration of time remaining in a particular user's contract term for a particular subscription service. Thus, the transaction analysis computing device may determine a status of a particular subscription service in relation to a particular user who is making payments for the service.

The transaction analysis computing device may, in addition, analyze one or more digital wallet transactions in the digital wallet transaction data associated with a user to determine that the user has relocated to a new or different geographic location, such as a different city, a different state, or a different country. A determination that the user has moved or relocated may indicate that a status of a particular subscription service is canceled, such as, for example, in the instance that the subscription service is not offered in the new or different geographic location.

In one embodiment, a new or different geographic location may be identified by the transaction analysis computing device based upon one or more location attributes associated with a user profile of the user and/or one or more location attributes associated with transactions in the digital wallet transaction data. For example, the transaction analysis computing device may analyze at least one transaction in a user's digital wallet transaction data to determine that the at least one transaction was initiated from a geographic location that is different from a geographic location associated with one or more previously initiated transactions (e.g., transactions occurring earlier in time).

In another embodiment, the transaction analysis computing device may also analyze an IP address of a user computing device of a user. The IP address of user computing device may be compared to a database or cross-reference table of IP addresses (e.g., a “geoIP” database or table), which may specify a geographic location associated with each IP address in the cross-reference table or database. Thus, the transaction analysis computing device may determine a geographic location of a user based upon the IP address of the user computing device, which may be used to initiate one or more digital wallet transactions. Thus, the transaction analysis computing device may determine that a user has relocated or moved to a different geographic location based upon a variety of digital wallet transaction attributes and/or geoIP data.

Based upon the determined status of one or more subscription services, the transaction analysis computing device may generate a promotional offer. The promotional offer may be generated in relation to the one or more subscription services and/or in relation to one or more other (e.g., one or more other related) subscription services. For example, in response to a determination that a contract term associated with subscription services (or an account associated with subscription services) will expire within a predetermined period of time (e.g., a predetermined number of days, weeks, or months), the transaction analysis computing device may generate a promotional offer, such as a promotional offer to renew the subscription services contract for a follow up or an additional term and/or a promotional offer to register for an additional term of service with respect to the subscription services and/or a promotional offer to register for different subscription services (or a different subscription services product), which may be offered by merchant offering the previous subscription services and/or a different merchant, such as a merchant offering related or similar subscription services.

Similarly, in response to a determination that a contract term associated with subscription services (or an account associated with subscription services) is relatively new and that the subscription services will not therefore expire within a predetermined period of time (e.g., a predetermined number of days, weeks, or months), the transaction analysis computing device may generate a promotional offer, such as a promotional offer to upgrade and/or otherwise make a change to the subscription services and/or a promotional offer to register for different or additional subscription services (or a different subscription services product), which may be offered by the merchant offering the previous subscription services and/or a different merchant, such as a merchant offering related or similar subscription services.

In addition, in response to a determination that a user has relocated to a different geographic area (as described above), the transaction analysis computing device may generate a promotional offer, such as a promotional offer to register for different or additional subscription services (or a different subscription services product), which may be offered by the merchant offering the previous subscription services if the merchant offers subscriptions services in the different geographic region and/or which may be offered by a different merchant, such as a merchant offering related or similar subscription services.

Further, in the exemplary embodiment, the transaction analysis computing device may provide one or more generated promotional offers to a user, such as via a message delivered to the user computing device, via an email delivered to an email address associated with the user, via mail delivered to a physical address of the user, and the like.

Thus, the transaction analysis computing device may receive digital wallet transaction data associated with a plurality of digital wallet transactions, analyze the digital wallet transaction data (e.g., one or more attributes associated with one or more digital wallet transactions in the transaction data), identify one or more digital wallet transactions associated with purchases of subscription services (and status of the subscription services), and generate, in response, one or more promotional offers, which may be delivered to users or purchasers of the subscription services to provide offers for new or upgraded subscription services, which may be offered by one or more merchants

The technical problems addressed by the transaction analysis computing platform include at least one of: (i) inability of accurately and rapidly determining and analyzing digital wallet transaction attributes, (ii) inability of identifying subscription services associated with a user based solely upon digital wallet transaction attributes, (iii) inability of determining a status of an identified subscription service based solely upon digital wallet transaction attributes, and (iv) inability of generating and digitally presenting promotional offers that that align with a user's subscription services and/or a statuses of a user's subscription services.

In addition, at least one technical problem with known systems is that, in view of the volume of financial transactions and the diversity of preferences between cardholders, it can be difficult, time-consuming, and/or resource-intensive to determine whether a financial transaction is fraudulent. To reduce a risk of fraudulent transactions, at least some known systems are configured to decline a financial transaction if the cardholder does not provide authentication in association with the financial transaction. The embodiments described herein address at least these technical problems. By processing financial transactions in the manner described in this disclosure, some embodiments improve user experience, user efficiency, and/or user interaction performance by using transaction data associated with a prior financial transaction to calculate risk associated with approving a request for authorization for a present financial transaction. Additionally or alternatively, some embodiments potentially reduce a quantity of requests to provide authentication. In this manner, the embodiments described herein may facilitate achieving a balance between convenience to the cardholder and security against fraudulent transactions. Additionally, some embodiments may reduce processor load by reducing an amount of data to be analyzed or processed, reduce network bandwidth usage and/or improve communication between systems by reducing an amount of data to be transmitted, improve processor security and/or data transmission security by using biometric data to process financial transactions, and/or reduce error rate by automating the analysis and processing of financial transactions. In some embodiments, the subject matter described herein may facilitate increasing processor speed and/or improving operating system resource allocation.

The methods and systems described herein may be implemented using computer programming or engineering techniques including computer software, firmware, hardware, or any combination or subset thereof, wherein the technical effects may be achieved by: (i) receiving digital wallet transaction data associated with a plurality of digital wallet transactions; (ii) analyzing the digital wallet transaction data; (iii) determining, based upon the analyzing, that the plurality of digital wallet transactions are associated with payments made for a subscription service; (iv) determining, based upon the analyzing, a status of the subscription service; (v) generating, based upon the status of the subscription service, a promotional offer in relation to at least one of the subscription service or a different subscription service; and (vi) providing the promotional offer to the user.

The resulting technical benefits achieved by the transaction analysis computing platform include at least one of: (i) accurately and rapidly determining and analyzing digital wallet transaction attributes, (ii) identifying subscription services associated with a user based solely upon digital wallet transaction attributes, (iii) determining a status of an identified subscription service based solely upon digital wallet transaction attributes, and (iv) generating and digitally presenting promotional offers that that align with a user's subscription services and/or a statuses of a user's subscription services.

As used herein, a “subscription service” may include any service offered for sale by a merchant in conjunction with a subscription or a contract term, such as a contract term for a period of time (e.g., months, years, etc.) A subscription service may thus include a contract term that specifies a number of periodic, recurring, payments in exchange for the service, such as a number of monthly payments distributed over a contract term of a number of months and/or years. Exemplary subscription services may include, but are not limited to, services such as internet services, television services, telephone services, music services, and the like.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are examples only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are examples only, and are thus not limiting as to the types of memory usable for storage of a computer program.

In one embodiment, a computer program is provided, and the program is embodied on a computer readable storage medium. In an example embodiment, the system is executed on a single computer system, without requiring a connection to a server computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the disclosure by way of example and not by way of limitation. It is contemplated that the disclosure has general application in industrial, commercial, and academic applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

In various embodiments, digital wallet transaction data is anonymized and/or aggregated prior to receipt by the transaction analysis computing device (e.g., in some cases, no personally identifiable information (PII) is received by the transaction analysis computing device). In other embodiments, the transaction analysis computing device may be configured to receive digital wallet transaction data that is not yet anonymized and/or aggregated; however, the transaction analysis computing device and may be configured to anonymize and/or aggregate the digital wallet transaction data. In such embodiments, any PII received by the transaction analysis computing device may be received and processed in an encrypted format, or may be received with the consent of users with which the PII is associated. In other words, users may be prompted, prior to collection and/or analysis of digital wallet transaction data, to opt-in or request participation in the processes implemented by the systems and methods described herein. In situations in which the systems discussed herein collect PII about individuals including users and/or merchants, users may be provided with an opportunity to control whether such information is collected or to control whether and/or how such information is used. In addition, certain data may be processed in one or more ways before it is stored or used, so that personally identifiable information is removed or anonymized.

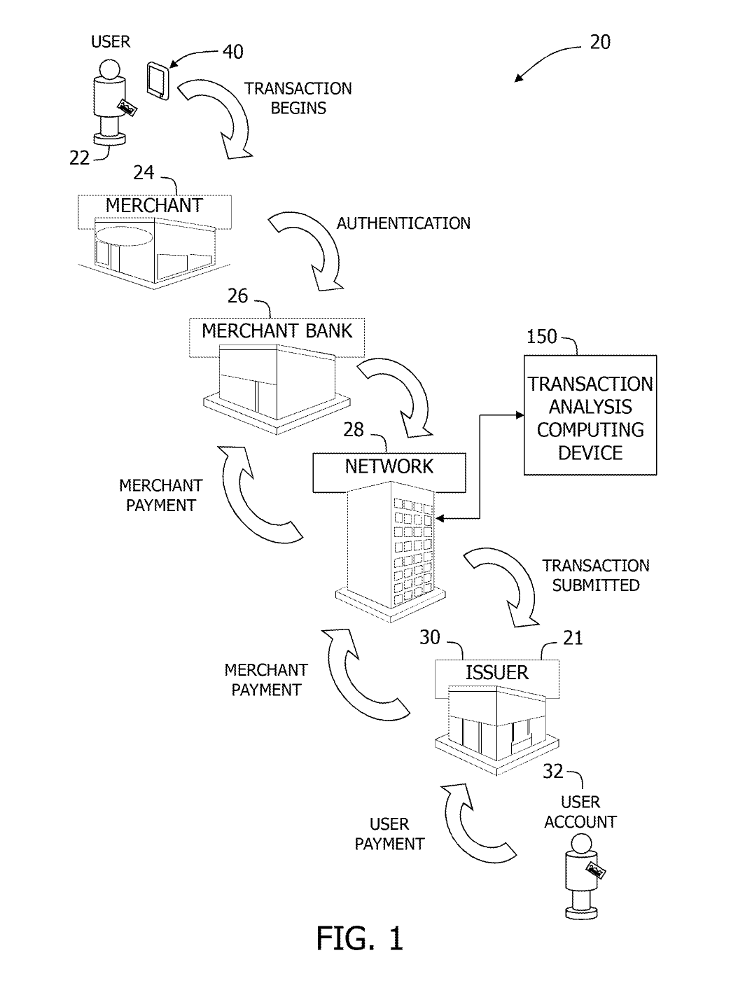

FIG. 1 is a schematic diagram illustrating an example transaction analysis platform for promoting subscription services to users based upon digital wallet transaction data. Embodiments described herein may relate to a transaction card system, such as a payment card payment system using the Mastercard interchange network. The Mastercard interchange network is a set of proprietary communications standards promulgated by Mastercard International Incorporated for the exchange of financial transaction data and the settlement of funds between financial institutions that are members of Mastercard International Incorporated. (Mastercard is a registered trademark of Mastercard International Incorporated located in Purchase, N.Y.). Embodiments described herein also relate to a transaction analysis computing device 150 that is communicatively coupled to an interchange network 28. Transaction analysis computing device 150 is configured to promote subscription services to users based upon digital wallet transaction data, as described herein.

In the example transaction analysis platform, a financial institution called the “issuer” or “issuing bank” issues an account, such as a credit card account, to the user 22, who uses the account to tender payment for a purchase from a merchant 24. In one embodiment, the user presents a digital wallet to merchant 24 (also known as a card-present transaction) using a user computing device. In another embodiment, the user does not present a digital wallet and instead performs a card-not-present transaction. For example, the card-not-present transaction may be initiated via a digital wallet application, through a website or web portal, via telephone, or any other method that does not require the user to present a physical payment card to merchant 24 (e.g., via scanning the digital wallet).

To accept payment with the transaction card, merchant 24 establishes an account with a financial institution that is part of the financial payment system. This financial institution is usually called the “merchant bank,” the “acquiring bank,” or the “acquirer.” In one embodiment, user 22 tenders payment for a purchase using a transaction card at a transaction processing device 40 (e.g., a point of sale device), then merchant 24 requests authorization from a merchant bank 26 for the amount of the purchase. The request is usually performed through the use of a point-of-sale terminal, which reads user 22's account information from a magnetic stripe, a chip, barcode, or embossed characters on the transaction card (e.g., a digital wallet) and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether user 22's account 32 is in good standing and whether the purchase is covered by user 22's available credit line. Based on these determinations, the request for authorization will be declined or accepted. If the request is accepted, an authorization code is issued to merchant 24.

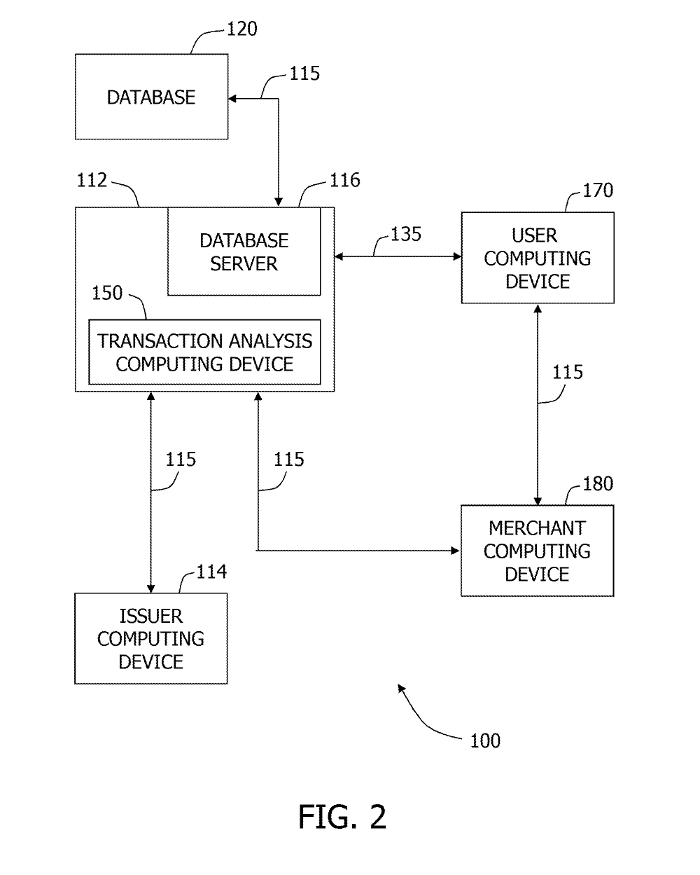

When a request for authorization is accepted, the available credit line of user 22's account 32 is decreased. Normally, a charge for a payment card transaction is not posted immediately to user 22's account 32 because certain rules do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If user 22 cancels a transaction before it is captured, a “void” is generated. If user 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional digital wallet transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, user account information, a type of transaction, information regarding the purchased item and/or service, and/or other suitable information, is associated with a transaction and transmitted between parties to the transaction as digital wallet transaction data, and may be stored by any of the parties to the transaction.

After a transaction is authorized and cleared, the transaction is settled among merchant 24, merchant bank 26, and issuer bank 30. Settlement refers to the transfer of financial data or funds among merchant 24's account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described above, the various parties to the payment card transaction include one or more of the parties shown in FIG. 1 such as, for example, user 22, merchant 24, merchant bank 26, interchange network 28 (also referred to herein as payment processor 28), issuer bank 30, and/or an issuer processor 21.

FIG. 2 is a block diagram of an example transaction analysis computing platform 100, in which a variety of computing devices are communicatively coupled to each other via a plurality of network connections. These network connections may be Internet, LAN/WAN (Local Area Network/Wide Area Network), or other connections capable of transmitting data across computing devices. Transaction analysis computing platform 100 includes transaction analysis computing device 150 and a database server 116. In one embodiment, transaction analysis computing device 150 and database server 116 are components of server system 112. Server system 112 may be a server, a network of multiple computer devices, a virtual computing device, or the like. Transaction analysis computing device 150 is connected to at least one user computing device 170, a merchant computing device 180, and an issuer computing device 114 via at least a network connection 115.

In one embodiment, transaction analysis computing device 150 is configured to receive digital wallet transaction data from merchant computing device 180, over a network connection 115. Transaction analysis computing device 150 may be operated by and/or affiliated with interchange network 28. Alternatively, transaction analysis computing device 150 may be operated by and/or affiliated with any entity that enables transaction analysis computing device 150 to function as described herein.

As noted with respect to FIG. 1, when a user performs a transaction at a merchant location and/or purchases subscription services, digital wallet transaction data is generated. Digital wallet transaction data may be transmitted across computer devices as a digital wallet transaction data message. In one embodiment, when a user performs a transaction at merchant computing device 180 associated with a merchant, digital wallet transaction data for the transaction is transmitted to server system 112. Server system 112 processes the digital wallet transaction data in the manner described with respect to FIG. 1 and also provides it to transaction analysis computing device 150. Transaction analysis computing device 150 is also configured to communicate with user computing device 170 via an electronic communication channel or method that is distinct from one used to communicate digital wallet transaction data. In the example embodiment, transaction analysis computing device 150 is configured to communicate with user computing device 170 via electronic communication channel 135.

The digital wallet transaction data message may also include a transaction amount, a transaction date, account data related to the payment card used to perform the transaction (e.g., primary account number associated with payment card, card expiration date, card issuer, card security code, or the like), a merchant identifier, stock-keeping unit (SKU) data relating to the goods or services purchased from the user, or the like.

Database server 116 is connected to database 120, which contains information on a variety of matters, as described below in greater detail. In one embodiment, database 120 is stored on server system 112 and can be accessed by potential users of server system 112. In an alternative embodiment, database 120 is stored remotely from server system 112 and may be non-centralized. Database 120 may include a single database having separated sections or partitions or may include multiple databases, each being separate from each other. Database 120 may store demographic data for each user in communication with transaction analysis computing device 150.

In the example embodiment, transaction analysis computing device 150 includes specifically designed computer hardware to perform the steps described herein, and includes specifically designed computer implementation instructions. Transaction analysis computing device 150 is a specially designed and customized computer device built to perform the specific functions of collecting and analyzing digital wallet transaction data and promoting subscription services to users based upon an analysis of the digital wallet transaction data, as described herein.

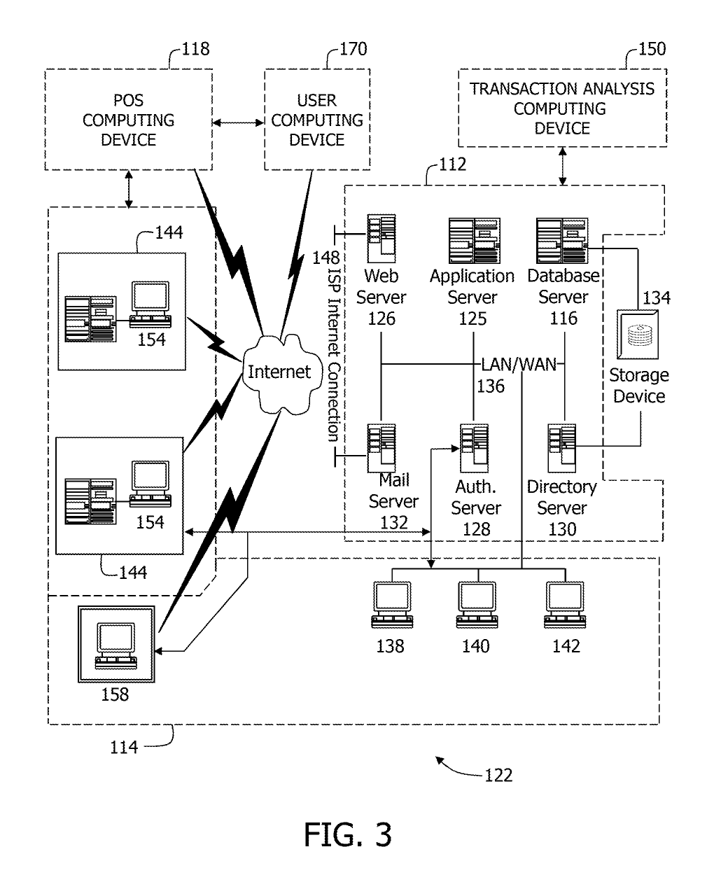

FIG. 3 is an expanded block diagram of an example embodiment of server architecture of a transaction analysis computer platform 100 including other computer devices in accordance with one embodiment of the present disclosure. Components in transaction analysis computer platform 100 are identified in FIG. 3 using the same reference numerals as used in FIG. 2. Transaction analysis computer platform 100 includes server system 112. Server system 112 further includes database server 116, an application server 125, a web server 126, an authentication server 128, a directory server 130, and a mail server 132. A storage device 134 is coupled to database server 116 and directory server 130. Servers 116, 125, 126, 128, 130, and 132 are coupled in a network connection, such as LAN/WAN 136. In addition, an issuer bank workstation 138 (similar to issuer computing device 114 shown in FIG. 2), acquirer bank workstation 140, and a third party processor workstation 142 may be coupled to LAN/WAN 136.

In the example embodiment, issuer bank workstation 138, acquirer bank workstation 140, and third party processor workstation 142 are coupled to LAN/WAN 136 using network connection 115 (shown in FIG. 2). Workstations 138, 140, and 142 are coupled to LAN/WAN 136 using an Internet link or are connected through an Intranet. In the example embodiment, transaction analysis computing device 150 is in communication with issuer bank workstation 138 and POS computing device 118 (which may be, for example, the same as merchant computing device 180 (as shown in FIG. 2)). User computer device 170 is connected to the Internet and may be a smartphone, personal computer, tablet computer, desktop, laptop, or similar computing device. Transaction analysis computing device 150 is configured to receive digital wallet transaction data, from POS computing device 118 and user computing device 170 via server system 112.

Each workstation 138, 140, and 142 is a computer with Internet access. Although the functions performed at the workstations typically are illustrated as being performed at respective workstations 138, 140, and 142, such functions can be performed at one of many personal computers coupled to LAN/WAN 136. Workstations 138, 140, and 142 are illustrated as being associated with separate functions only to facilitate an understanding of the different types of functions that can be performed by individuals having access to LAN/WAN 136.

Server system 112 is configured to be communicatively coupled to various individuals, including employees and third parties 144 (e.g., auditors, developers, merchants, acquirers, issuers, etc.), using an ISP Internet connection 148. The communication in the example embodiment is illustrated as being performed using the Internet. However, any other wide area network (WAN) type communication can be utilized in other embodiments. In other words, the systems and processes are not limited to being practiced using the Internet.

In the example embodiment, any authorized individual having a workstation 154 can access transaction analysis computer platform 100. At least one of the client systems includes a manager workstation 156 located at a remote location. Workstations 154 and 156 are personal computers having a web browser. Also, workstations 154 and 156 are configured to communicate with server system 112. Furthermore, authentication server 128 communicates with remotely located client systems, including a client system 156 using a telephone link. Authentication server 128 is configured to communicate with other client workstations 138, 140, and 142 as well.

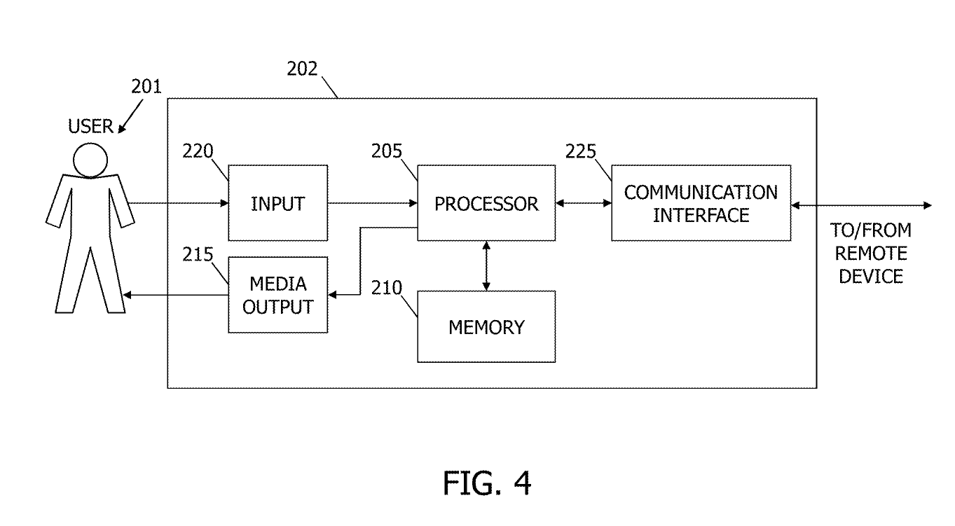

FIG. 4 illustrates an example configuration of a user system, such as a user computing device configured to transmit data to transaction analysis computing device 150. User system 202 may include, but is not limited to, user computing device 170 (shown in FIG. 2). In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. For example, media output component 215 may be a display component configured to display component lifecycle data in the form of reports, dashboards, communications, or the like. In some embodiments, media output component 215 includes an output adapter such as a video adapter and/or an audio adapter. An output adapter is operatively coupled to processor 205 and operatively connectable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively connectable to a remote device such as server system 112 (shown in FIG. 2). Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

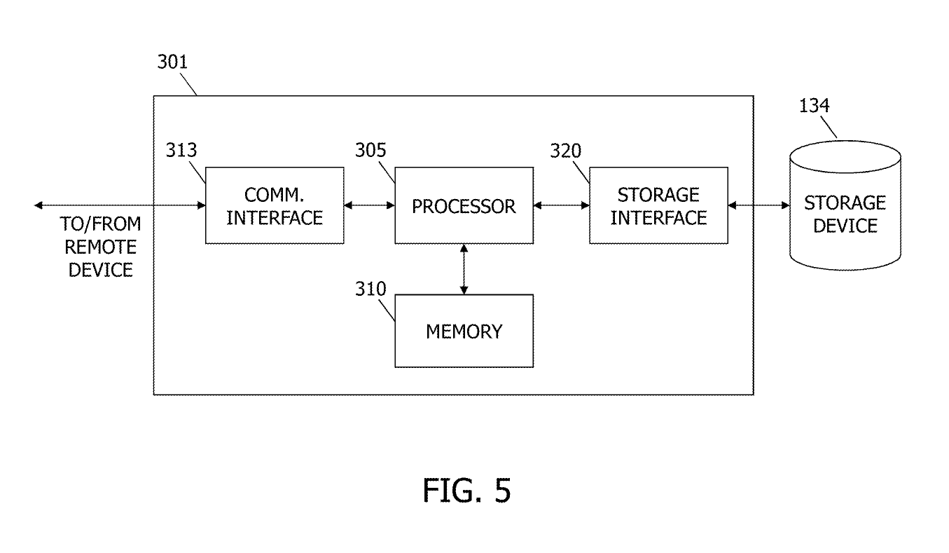

FIG. 5 illustrates an example configuration of a server system 301 such as the server system 112 shown in FIG. 2 that includes transaction analysis computing device 150 (shown in FIG. 2). Server system 301 may include, but is not limited to, database server 116 (shown in FIG. 2) or transaction analysis computing device 150 (shown in FIG. 2). In some embodiments, server system 301 is similar to server system 112 (shown in FIG. 2).

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. More specifically, the instructions may cause various data manipulations on data stored in storage 134 (e.g., create, read, update, and delete procedures). It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.)

Processor 305 is operatively coupled to a communication interface 313 such that server system 301 is capable of communicating with a remote device such as a user system or another server system 301. For example, communication interface 313 may receive communications from issuer computing devices 114 via the Internet, as illustrated in FIG. 2.

Processor 305 may also be operatively coupled to a storage device 134. Storage device 134 is any computer-operated hardware suitable for storing and/or retrieving data. In some embodiments, storage device 134 is integrated in server system 301. In other embodiments, storage device 134 is external to server system 301 and is similar to database 120 (shown in FIG. 2). For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

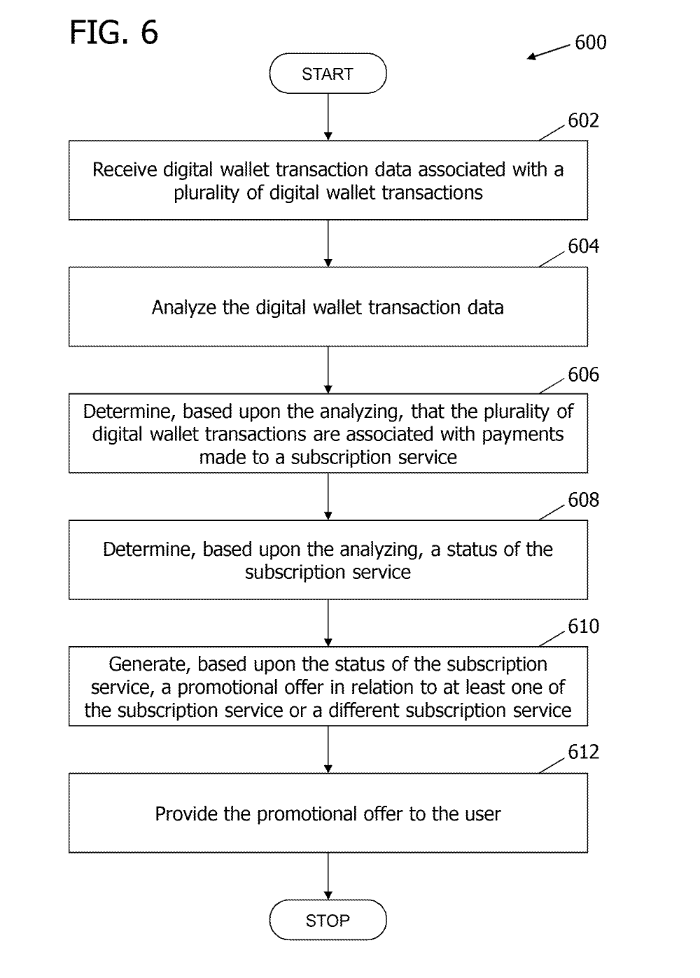

FIG. 6 is an example flow diagram illustrating a method flow 600 by which transaction analysis computing device 150 (shown in FIG. 2) receives and analyzes digital wallet transaction data to promote subscription services to users based upon an analysis of the digital wallet transaction data, as described herein. Accordingly, in the example embodiment transaction analysis computing device 150 receives digital wallet transaction data associated with one or more digital wallet transactions (step 602). For example, as described above, a user may use a digital wallet to purchase a variety of goods and services, such as, in some cases, subscription services. The digital wallet transaction data received by transaction analysis computing device 150 may therefore be associated with a variety of digital wallet transactions or types of digital wallet transactions, including, for example, digital wallet transactions associated with the purchase of one or more subscription services.

In various embodiments, transaction analysis computing device 150 may analyze the digital wallet transaction data to identify digital wallet transaction data associated with the purchase of one or more subscription services (step 604). More particularly, transaction analysis computing device 150 may analyze one or more attributes of the digital wallet transaction data to determine that a particular transaction or group of transactions in the digital wallet transaction data are associated with the purchase of one or more subscription services (step 606).

In some embodiments, the attributes associated with each transaction in the digital wallet transaction data may include, but are not limited to, a purchase amount associated with one or more digital wallet transactions in the digital wallet transaction data, a date and/or timestamp associated with one or more transactions in the digital wallet transaction data, an identifier or purchase code associated with one or more transactions in the digital wallet transaction data, a merchant name or merchant identifier associated with one or more transactions in the digital wallet transaction data, and the like. Transactions analysis computing device 150 may analyze these attributes in combination with one another and/or independently to determine that a particular transaction or a particular group of transactions is associated with the purchase of a subscription service.

For example, transaction analysis computing device 150 may analyze a purchase amount associated with a plurality of transactions in conjunction with a date and/or timestamp associated with each of the plurality of transactions to determine that the purchase amount recurs periodically in the digital wallet transaction data associated with a particular user. Specifically, transaction analysis computing device 150 may determine that a particular purchase amount recurs periodically (e.g., weekly, monthly, annually) in a user's digital wallet transaction data. Such a pattern may suggest or indicate that the transactions associated with the particular purchase amount and/or date and/or timestamp are associated with a purchase of subscription services, which, as described above, may include a periodically recurring payment or billing cycle.

In addition, transaction analysis computing device 150 may analyze an identifier or purchase code associated with one or more transactions to determine that the one or more transactions are associated with a purchase of subscription services. For instance, a particular subscription service may be associated with or identified by an identifier, which may be applied by a merchant offering the subscription services for sale, and which may be used by transaction analysis computing device 150 to determine that the one or more transactions associated with the identifier are associated with a purchase of the subscription services.

Similarly, transaction analysis computing device 150 may analyze a merchant name and/or merchant identifier associated with one or more transactions to determine that the one or more transactions are associated with a purchase of subscription services. For example, transaction analysis computing device 150 may store and/or retrieve a stored record of merchant names and/or merchant identifiers associated with merchants known to offer subscription services. If a merchant name and/or merchant identifier associated with one or more transactions in the digital wallet transaction data matches a stored merchant name and/or stored merchant identifier, transaction analysis computing device 150 may determine that the one or more transactions are associated with a purchase of subscription services from the merchant.

Thus, the attributes associated with each transaction in the digital wallet transaction data may be analyzed, as described above, to determine that a particular transaction or group of transactions are associated with the purchase of one or more subscription services. The attributes may be analyzed independently and/or in different combinations with one another to make this determination, and as described above, an individual transaction and/or a group of transactions (such as a group of transactions recurring in the digital wallet transaction data as part of a periodic billing cycle) may be identified by transaction analysis computing device 150 as being associated with the purchase of a particular subscription service and/or a plurality of subscription services.

In response to determining that one or more transactions in the digital wallet transaction data are associated with the purchase of a subscription service (e.g., payments made to a subscription service), transaction analysis computing device 150 may, in addition, determine, based upon the analysis of one or more attributes associated with each transaction, a status of a particular subscription service (step 608). For example, in some embodiments, transaction analysis computing device 150 may analyze digital wallet transaction data associated with the purchase of a particular subscription service (identified as described above) to determine a number of payments made to the subscription service. In other words, transaction analysis computing device 150 may determine a number of transactions or transaction records in the digital wallet transaction data associated with payments made in conjunction with the purchase of a particular subscription service.

The number of payments may indicate, for example, an amount of time remaining in a user's contract term for the subscription services. For example, if a user has made eleven payments in association with the purchase of a particular subscription service, transaction analysis computing device 150 may determine (or infer) that the user's contract term, which may be for a period of twelve months, is about to expire. Similarly, if a user has only made one or two payments in association with the purchase of a particular subscription service, transaction analysis computing device 150 may determine (or infer) that the user's contract term, which, again, may be for a period of twelve months, is only just beginning.

In addition, and in some embodiments, transaction analysis computing device 150 may receive or obtain from a merchant offering the particular subscription service and/or a record of database of records associated with the particular subscription service, a known term of the subscription service. In such a case, it may not be necessary for transaction analysis computing device 150 to infer a contract term. Rather, where transaction analysis computing device 150 is able to obtain or determine (e.g., based upon an analysis of digital wallet data associated with a number of users who have purchased the particular subscription service) a contract term associated with a subscription service, transaction analysis computing device 150 may determine, based upon the known contract term, a time period or duration of time remaining in a particular user's contract term for a particular subscription service. Thus, transaction analysis computing device 150 may determine a status of a particular subscription service in relation to a particular user who is making payments for the service.

Transaction analysis computing device 150 may, in addition, analyze one or more digital wallet transactions in the digital wallet transaction data associated with a user to determine that the user has relocated to a new or different geographic location, such as a different city, a different state, or a different country. A determination that the user has moved or relocated may indicate that a status of a particular subscription service is canceled, such as, for example, in the instance that the subscription service is not offered in the new or different geographic location.

In one embodiment, a new or different geographic location may be identified by transaction analysis computing device 150 based upon one or more location attributes associated with a user profile of the user and/or one or more location attributes associated with transactions in the digital wallet transaction data. For example, transaction analysis computing device 150 may analyze at least one transaction in a user's digital wallet transaction data to determine that the at least one transaction was initiated from a geographic location that is different from a geographic location associated with one or more previously initiated transactions (e.g., transactions occurring earlier in time).

In another embodiment, transaction analysis computing device 150 may also analyze an IP address of user computing device 170 of a user. The IP address of user computing device 170 may be compared to a database or cross-reference table of IP addresses (e.g., a “geoIP” database or table), which may specify a geographic location associated with each IP address in the cross-reference table or database. Thus, transaction analysis computing device 150 may determine a geographic location of a user based upon the IP address of user computing device 170, which may be used to initiate one or more digital wallet transactions. Thus, transaction analysis computing device 150 may determine that a user has relocated or moved to a different geographic location based upon a variety of digital wallet transaction attributes and/or geoIP data.

Based upon the determined status of one or more subscription services, transaction analysis computing device 150 may generate a promotional offer (step 610). The promotional offer may be generated in relation to the one or more subscription services and/or in relation to one or more other (e.g., one or more other related) subscription services. For example, in response to a determination that a contract term associated with subscription services (or an account associated with subscription services) will expire within a predetermine period of time (e.g., a predetermined number of days, weeks, or months), transaction analysis computing device 150 may generate a promotional offer, such as a promotional offer to renew the subscription services contract for a follow up or an additional term and/or a promotional offer to register for an additional term of service with respect to the subscription services and/or a promotional offer to register for different subscription services (or a different subscription services product), which may be offered by merchant offering the previous subscription services and/or a different merchant, such as a merchant offering related or similar subscription services.

Similarly, in response to a determination that a contract term associated with subscription services (or an account associated with subscription services) is relatively new or recent and that the subscription services will not therefore expire within a predetermine period of time (e.g., a predetermined number of days, weeks, or months), transaction analysis computing device 150 may generate a promotional offer, such as a promotional offer to upgrade and/or otherwise make a change to the subscription services and/or a promotional offer to register for different or additional subscription services (or a different subscription services product), which may be offered by merchant offering the previous subscription services and/or a different merchant, such as a merchant offering related or similar subscription services.

In addition, in response to a determination that a user has relocated to a different geographic area (as described above), transaction analysis computing device 150 may generate a promotional offer, such as a promotional offer to register for different or additional subscription services (or a different subscription services product), which may be offered by the merchant offering the previous subscription services if the merchant offers subscriptions services in the different geographic region and/or which may be offered a different merchant, such as a merchant offering related or similar subscription services.

Further, in the exemplary embodiment, transaction analysis computing device 150 may provide one or more generated promotional offers to a user, such as via a message delivered to user computing device 170, via an email delivered to an email address associated with the user, via mail delivered to a physical address of the user, and the like (step 612).

Thus, transaction analysis computing device 150 may receive digital wallet transaction data associated with a plurality of digital wallet transactions, analyze the digital wallet transaction data (e.g., one or more attributes associated with one or more digital wallet transactions in the transaction data), identify one or more digital wallet transactions associated with purchases of subscription services (and status of the subscription services), and generate, in response, one or more promotional offers, which may be delivered to users or purchasers of the subscription services to provide offers for new or upgraded subscription services, which may be offered by one or more merchants.

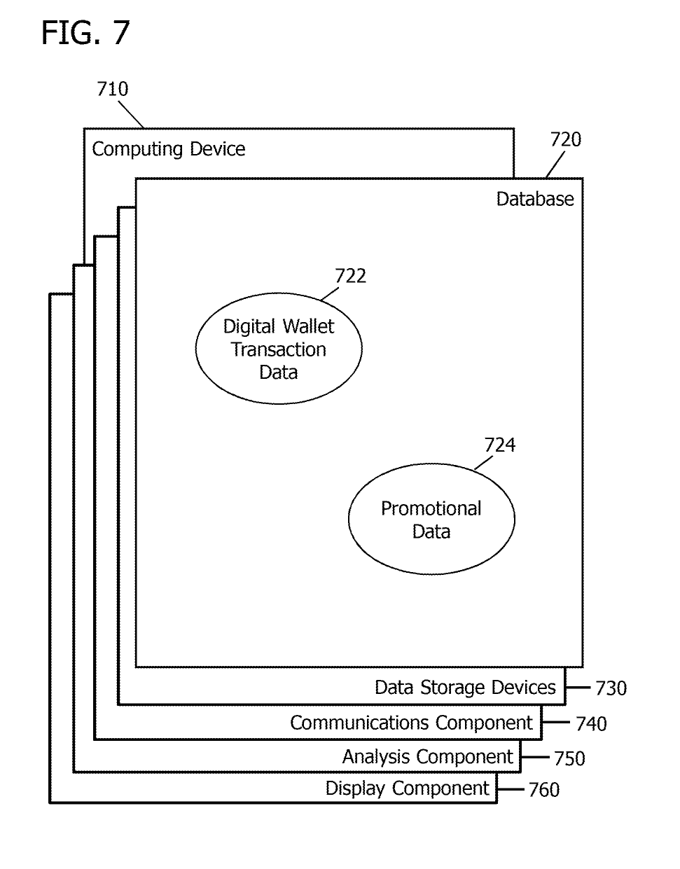

FIG. 7 shows an example configuration of a database 720 within a computing device 710, along with other related computing components, that may be used to promote subscription services to users based upon digital wallet transaction data, as described herein. In some embodiments, computing device 710 is similar to server system 112 (shown in FIG. 2). In some embodiments, database 720 is similar to database 120 (shown in FIG. 2). In the example embodiment, database 720 includes digital wallet transaction data 722 and promotional data 724, as described above.

Computing device 710 also includes data storage devices 730. Computing device 710 also includes communications component 740 that may perform, for example, the receiving the digital wallet transaction data 602 described with respect to FIG. 6. Further, computing device 710 also includes an analysis component 750 that may perform the analyzing the digital wallet transaction data 604 and/or the determining the plurality of digital wallet transactions associated with payments made to a subscription service 606 and/or the determining the status of a subscription service 608 and/or the generating the promotional offer 610 described in FIG. 6. In addition, computing device 710 also includes a display component 760 that may perform a display function, such as providing the promotional offer to the user device 612 (such as user computing device 170) as described in FIG. 6.

As will be appreciated based on the foregoing specification, the above-described embodiments of the disclosure may be implemented using computer programming or engineering techniques including computer software, firmware, hardware or any combination or subset thereof, wherein the technical effect is to collect digital wallet data from a digital wallet transaction initiated by a user for determining the user's demographics. Any such resulting program, having computer-readable code means, may be embodied or provided within one or more computer-readable media, thereby making a computer program product, (i.e., an article of manufacture), according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-based method for promoting subscription services to a user based upon digital wallet transaction data, said method performed using a transaction analysis computing device comprising at least one processor in communication with at least one memory device, said method comprising:
receiving digital wallet transaction data associated with a plurality of digital wallet transactions;
analyzing the digital wallet transaction data;
determining, based upon the analyzing, that the plurality of digital wallet transactions are associated with payments made for a subscription service;
determining, based upon the analyzing, a status of the subscription service;
generating, based upon the status of the subscription service, a promotional offer in relation to at least one of the subscription service or a different subscription service; and
providing the promotional offer to the user.

2. The method of claim 1, wherein the determining, based upon the analyzing, that the plurality of digital wallet transactions are associated with payments made to the subscription service comprises:
determining that the plurality of digital wallet transactions are made on a periodic basis and recur over a period of time; and
determining, in response, that the plurality of digital wallet transactions are associated with the subscription service.

3. The method of claim 1, wherein the determining, based upon the analyzing, the status of the subscription service comprises:
identifying at least one transaction in the digital wallet transaction data that is not associated with a payment made to the subscription service;
analyzing the at least one transaction; and
determining, based upon the analyzing, that the user has relocated to a new geographic region based upon the analyzing.

4. The method of claim 3, further comprising generating, in response to determining that the user has relocated, the promotional offer associated with the different subscription service.

5. The method of claim 1, wherein the determining, based upon the analyzing, the status of the subscription service comprises:
analyzing the plurality of digital wallet transactions;
determining, based upon the analyzing, a number of payments made to the subscription service; and
determining that a term associated with the subscription service will expire within a predetermined period of time.

6. The method of claim 5, further comprising generating, in response to determining that the term associated with the subscription service will expire within the predetermined period of time, the promotional offer, wherein the promotional offer includes an offer to register for an additional term of service.

7. The method of claim 1, wherein the determining, based upon the analyzing, the status of the subscription service comprises:
analyzing the plurality of digital wallet transactions;
determining, based upon the analyzing, a number of payments made to the subscription service; and
determining that a term associated with the subscription service will not expire within a predetermined period of time.

8. The method of claim 7, further comprising generating, in response to determining that the term associated with the subscription service will not expire within the predetermined period of time, the promotional offer, wherein the promotional offer includes an offer to register for an upgraded subscription service.

9. A transaction analysis computing device comprising at least one processor in communication with at least one memory device, said transaction analysis computing device configured to:
receive digital wallet transaction data associated with a plurality of digital wallet transactions;
analyze the digital wallet transaction data;
determine, based upon the analysis, that the plurality of digital wallet transactions are associated with payments made for a subscription service;
determine, based upon the analyzing, a status of the subscription service;
generate, based upon the status of the subscription service, a promotional offer in relation to at least one of the subscription service or a different subscription service; and
provide the promotional offer to the user.

10. The transaction analysis computing device of claim 9, wherein to determine, based upon the analysis, that the plurality of digital wallet transactions are associated with payments made to the subscription service, the transaction analysis computing device is configured to:
determine that the plurality of digital wallet transactions are made on a periodic basis and recur over a period of time; and
determine, in response, that the plurality of digital wallet transactions are associated with the subscription service.

11. The transaction analysis computing device of claim 9, wherein to determine, based upon the analysis, the status of the subscription service, the transaction analysis computing device is configured to:
identify at least one transaction in the digital wallet transaction data that is not associated with a payment made to the subscription service;
analyze the at least one transaction; and
determine, based upon the analysis, that the user has relocated to a new geographic region based upon the analyzing.

12. The transaction analysis computing device of claim 11, wherein the transaction analysis computing device is further configured to generate, in response to determining that the user has relocated, the promotional offer associated with the different subscription service.

13. The transaction analysis computing device of claim 9, wherein to determine, based upon the analysis, the status of the subscription service, the transaction analysis computing device is configured to:
analyze the plurality of digital wallet transactions;
determine, based upon the analysis, a number of payments made to the subscription service; and
determine that a term associated with the subscription service will expire within a predetermined period of time.

14. The transaction analysis computing device of claim 13, wherein the transaction analysis computing device is further configured to generate, in response to determining that the term associated with the subscription service will expire within the predetermined period of time, the promotional offer, wherein the promotional offer includes an offer to register for an additional term of service.

15. The transaction analysis computing device of claim 9, wherein to determine, based upon the analysis, the status of the subscription service, the transaction analysis computing device is configured to:
analyze the plurality of digital wallet transactions;
determine, based upon the analysis, a number of payments made to the subscription service; and
determine that a term associated with the subscription service will not expire within a predetermined period of time.

16. The transaction analysis computing device of claim 15, wherein the transaction analysis computing device is further configured to generate, in response to determining that the term associated with the subscription service will not expire within the predetermined period of time, the promotional offer, wherein the promotional offer includes an offer to register for an upgraded subscription service.

17. A non-transitory computer readable medium that includes executable instructions for promoting subscription services to a user based upon digital wallet transaction data, wherein when executed by a transaction analysis computing device comprising at least one processor in communication with at least one memory device, the computer executable instructions cause the transaction analysis computing device to:
receive digital wallet transaction data associated with a plurality of digital wallet transactions;
analyze the digital wallet transaction data;
determine, based upon the analysis, that the plurality of digital wallet transactions are associated with payments made for a subscription service;
determine, based upon the analyzing, a status of the subscription service;
generate, based upon the status of the subscription service, a promotional offer in relation to at least one of the subscription service or a different subscription service; and
provide the promotional offer to the user.

18. The non-transitory computer readable medium of claim 17, wherein to determine, based upon the analysis, that the plurality of digital wallet transactions are associated with payments made to the subscription service, the computer executable instructions cause the transaction analysis computing device to:
determine that the plurality of digital wallet transactions are made on a periodic basis and recur over a period of time; and
determine, in response, that the plurality of digital wallet transactions are associated with the subscription service.

19. The non-transitory computer readable medium claim 17, wherein to determine, based upon the analysis, the status of the subscription service, the computer executable instructions cause the transaction analysis computing device to:
identify at least one transaction in the digital wallet transaction data that is not associated with a payment made to the subscription service;
analyze the at least one transaction; and
determine, based upon the analysis, that the user has relocated to a new geographic region based upon the analyzing.

20. The non-transitory computer readable medium of claim 19, wherein the computer executable instructions further cause the transaction analysis computing device to generate, in response to determining that the user has relocated, the promotional offer associated with the different subscription service.

21. The non-transitory computer readable medium of claim 17, wherein to determine, based upon the analysis, the status of the subscription service, the computer executable instructions cause the transaction analysis computing device to:
analyze the plurality of digital wallet transactions;
determine, based upon the analysis, a number of payments made to the subscription service; and
determine that a term associated with the subscription service will expire within a predetermined period of time.

22. The non-transitory computer readable medium of claim 21, wherein the computer executable instructions further cause the transaction analysis computing device to generate, in response to determining that the term associated with the subscription service will expire within the predetermined period of time, the promotional offer, wherein the promotional offer includes an offer to register for an additional term of service.

23. The non-transitory computer readable medium of claim 17, wherein to determine, based upon the analysis, the status of the subscription service, the computer executable instructions cause the transaction analysis computing device to:
analyze the plurality of digital wallet transactions;
determine, based upon the analysis, a number of payments made to the subscription service; and
determine that a term associated with the subscription service will not expire within a predetermined period of time.

24. The non-transitory computer readable medium of claim 23, wherein the computer executable instructions cause the transaction analysis computing device to generate, in response to determining that the term associated with the subscription service will not expire within the predetermined period of time, the promotional offer, wherein the promotional offer includes an offer to register for an upgraded subscription service.
